(19) United States
(12) Patent Application Publication
(10) Pub. No.: US 2009/0315893 A1
(43) Pub. Date: Dec. 24, 2009

(54) USER AVATAR AVAILABLE ACROSS COMPUTING APPLICATIONS AND DEVICES

(75) Inventors: Derek H. Smith, Bothell, WA (US); Brendan Reville, Seattle, WA (US); Stacey Law, Redmond, WA (US); Thomas Langan, Seattle, WA (US); Bjorn Toft Madsen, Ashby de la Zouch (GB); Rodney Alan Boyd, London (GB); Jerry Alan Johnson, Medina, WA (US); Tian Fung Lim, Seattle, WA (US); Richard Henry Irving, Kirkland, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/141,109

(22) Filed: Jun. 18, 2008

(51) Int. Cl. G06T 13/00; G06T 1/00

(52) U.S. Cl. 345/473; 345/418

(57) ABSTRACT

An avatar along with its accessories, emotes, and animations may be system provided and omnipresent. In this manner, the avatar and its accessories, emotes, and animations may be available across multiple environments provided or exposed by multiple avatar computing applications, such as computer games, chats, forums, communities, or instant messaging services. An avatar system may change the avatar and its accessories, emotes, and animations, e.g. pursuant to a request from the user, instructions from an avatar computing application, or updates provided by software associated with a computing device. The avatar and its accessories, emotes, and animations may be changed by a system or computing application associated with a computing device outside of a computer game or computing environment in which the avatar may be rendered or used by the user.

### BACKGROUND

An avatar is a computer representation of a user and typically takes the form of a two-dimensional (2D) or three-dimensional (3D) model in various environments such as computer games, applications, chats, forums, communities, and instant messaging services, for example. An avatar may be thought of as an object representing the embodiment of a user, and may represent their actions and aspects of their persona, beliefs, interests, or social status.

Some environments allow a user to upload an avatar image that may have been designed by the user or acquired from elsewhere. Other environments may generate an avatar for a user or allow a user to select an avatar from a preset list. A user may customize an avatar by adding hairstyle, skin tone, body build, etc. An avatar may also be provided with accessories, emotes, and animations.

Typically, an avatar cannot move between different environments and may exist only within the context of a single environment. For example, an avatar created for one environment such as a particular computer game, as well as the avatar's accessories, emotes, and animations, cannot be used in another environment such as a different computer game.

### SUMMARY

An avatar along with its accessories, emotes, and animations may be system provided and omnipresent. The avatar and its accessories, emotes, and animations may be available across multiple environments provided or exposed by multiple avatar computing applications, such as computer games, chats, forums, communities, or instant messaging services.

In an implementation, an avatar system may change the avatar and its accessories, emotes, and animations, e.g. pursuant to a request from the user, instructions from an avatar computing application, or updates provided by software associated with a computing device. The avatar and its accessories, emotes, and animations may be changed by a system or computing application associated with a computing device outside of a computer game or computing environment in which the avatar may be rendered or used by the user.

In an implementation, a closet may be provided as system software associated with a computing device. The closet may be provided to the user at any time over any computing application, and may allow the user to apply accessories they already own to an avatar, as well as to try on accessories they do not own, as stored in a marketplace for example, and to purchase the accessories before applying them.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there are shown in the drawings example constructions of the embodiments; however, the embodiments are not limited to the specific methods and instrumentalities disclosed. In the drawings:

FIG. 1 shows an example of a computing environment in which aspects and embodiments may be potentially exploited;

FIG. 2 is an operational flow of an implementation of a method for providing an avatar across multiple computing environments;

FIG. 3 is an operational flow of an implementation of a method for providing features to an avatar;

FIG. 4 is an operational flow of an implementation of a method for rendering an avatar;

FIG. 5 is an operational flow of another implementation of a method for rendering an avatar; and

FIG. 6 illustrates functional components of an example multimedia console computing environment.

### DETAILED DESCRIPTION

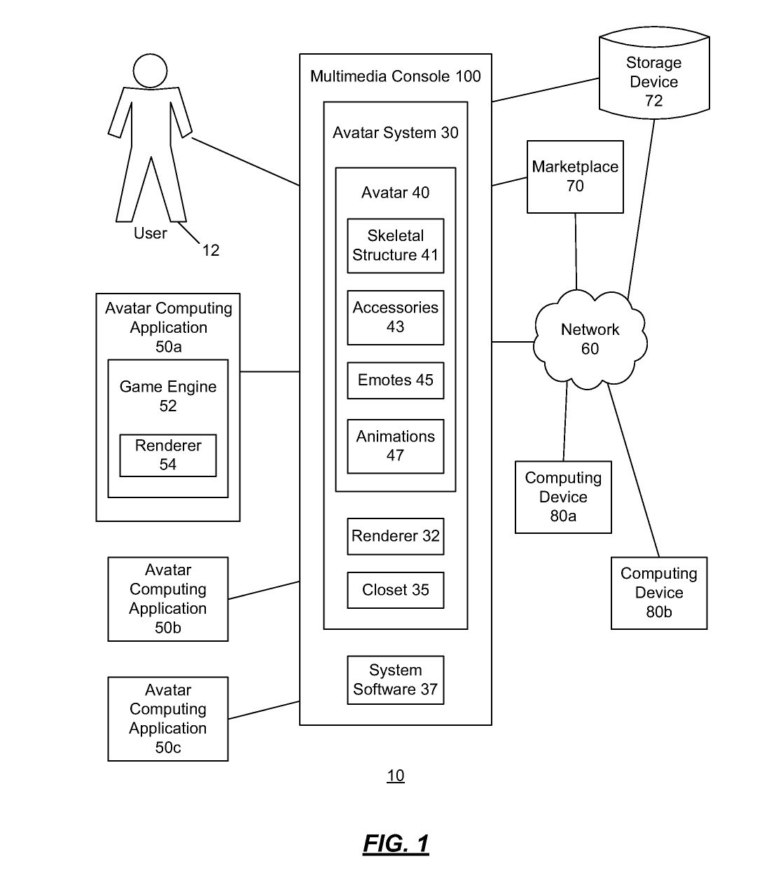

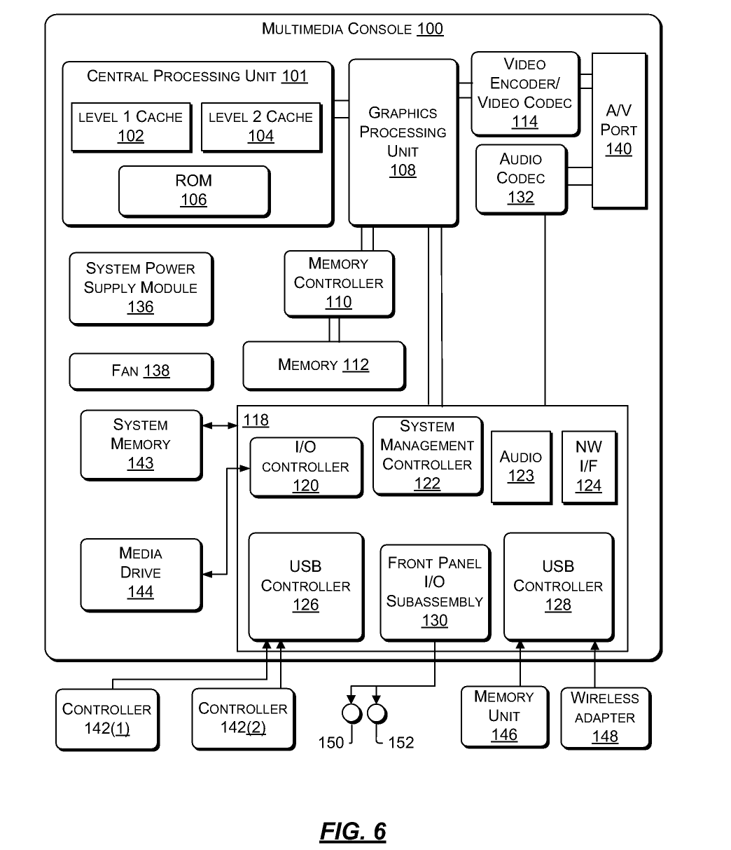

FIG. 1 shows an example of a computing environment 10 in which aspects and embodiments may be potentially exploited. The computing environment 10 includes a computing device shown as a multimedia console 100. Although a multimedia console 100 may be described with respect to aspects and embodiments herein, it is contemplated that any computing device may be used such as a personal computer (PC), a gaming console, a handheld computing device, a personal digital assistant (PDA), a mobile phone, etc. An example multimedia console 100 is described with respect to FIG. 6.

The multimedia console 100 may include an avatar system 30 that comprises an avatar 40. Although only one avatar is shown in the avatar system 30, it is contemplated that the avatar system 30 may maintain any number of avatars. The avatar system 30 may reside in the multimedia console 100 as system software.

A user 12 may access and interact with avatar computing applications, such as avatar computing applications 50a, 50b, and 50c, via the multimedia console 100. Each avatar computing application may be a computer game or other application that renders or otherwise uses the avatar 40 in an environment such as a chat, a forum, a community, or an instant messaging service. Although only three avatar computing applications 50a, 50b, and 50c are illustrated in FIG. 1, it is contemplated that any number of avatar computing applications may be associated with a computing device such as the multimedia console 100.

In an implementation, an avatar computing application such as avatar computing application 50a may comprise a game engine 52. As described further herein, e.g. with respect to the methods 400 and 500, the game engine 52 may receive an avatar 40 drawn or otherwise rendered by a renderer 32 of the avatar system 30 or may render an avatar 40 using its own renderer 54.

The avatar 40, along with its accessories 43, emotes 45, and animations 47 may be system provided and omnipresent. In this manner, the avatar 40 and its accessories 43, emotes 45, and animations 47 may be available across multiple environments provided or exposed by multiple avatar computing applications, such as the avatar computing applications 50a, 50b, and 50c. The avatar system 30 may change the avatar 40 and its accessories 43, emotes 45, and animations 47, e.g. pursuant to a request from the user 12, instructions from an avatar computing application, or updates provided by software associated with the multimedia console 100 such as system software 37. In an implementation, the avatar 40 and its accessories 43, emotes 45, and animations 47 may be changed by a system or computing application associated with the multimedia console 100 outside of a computer game or computing environment in which the avatar 40 may be rendered or used by the user 12.

The avatar system 30 may maintain a skeletal structure 41 for the avatar 40. The skeletal structure 41 may comprise a standardized skeleton that allows an avatar computing application to move parts of the skeleton at well-defined pivot points. Therefore, any avatar computing application may animate any avatar with only knowledge of the standard skeletal structure 41 and no other specific knowledge about the appearance of the associated avatar.

The avatar 40 may have accessories 43 such as clothing, handbags, sunglasses, etc. The accessories 43 may currently be used by the avatar 40 in an avatar computing application or may be available to the avatar for selection and use at a later time. The accessories 43 may be stored in storage associated with the multimedia console 100, such as a storage device 72. The storage device 72 may be any type of computer data storage and may be internal to or external from the multimedia console 100. The storage device 72 may store data directed to users (e.g., profiles), avatars, computing applications, etc. Associated data may be stored on any number of storage devices, although only one storage device 72 is shown.

System software 37 of the multimedia console 100 may allow the user 12 to apply accessories 43 to the avatar 40. A profile of the user 12 may be stored, e.g. in the storage device 72, and may record which accessories 43 the user 12 owns and which accessories 43 are currently applied to the avatar 40.

Accessories may be provided by or otherwise available from avatar computing applications and/or a marketplace 70. The marketplace 70 may be accessible to the user 12 via the multimedia console 100. In an implementation, the accessories 43 may be awarded by avatar computing applications, acquired for free, or purchased in a marketplace such as the marketplace 70. Each accessory may include a 3D mesh, one or more bitmapped textures, and information on where the accessory may be placed on the avatar 40.

Like avatars, the accessories 43 may be system provided and omnipresent, and therefore may be updated or changed by the system software 37 associated with the multimedia console 100, outside of any computing application that renders or otherwise uses the avatar 40. In this manner, the same avatar and accessory functionality may be available in multiple avatar computing applications and multiple environments.

Each accessory may use a standard mesh format, allowing it to be rendered over the skeletal structure 41. As an avatar computing application is animating the skeletal structure 41, the accessory meshes automatically move and deform to match the skeletal structure 41, allowing the avatar computing application to be agnostic as to the appearance or even presence of the accessories 43.

Thus, any avatar computing application may render the avatar 40 or have the avatar 40 rendered for them without any specific knowledge of the accessories 43 possessed by the avatar 40. Once an accessory appears on the avatar 40, the avatar system 30 may provide the corresponding meshes to any avatar computing application that requests avatar assets for rendering. In this way, for example, one computer game may provide an avatar with, for example, a shirt and that same shirt will still be on the avatar in a different computer game. This allows accessories to be granted by any entity (e.g., a computer game, a marketplace, etc.) to appear in various different environments (e.g., different computer games, chats, forums, communities, instant messaging services, etc.).

Each accessory that may be granted to the avatar 40 may be added to a list of accessories that may be maintained outside of the avatar computing application or environment that granted the accessory. The user 12 may add accessories to or remove them from the avatar 40 in an editing application referred to as a closet 35, comprised within the avatar system 30. The closet 35 may comprise a user interface for allowing the user 12 to modify the set of accessories 43 applied to the avatar 40. In addition to allowing the user 12 to change the accessories 43 of the avatar 40, the closet 35 may also allow the user 12 to change the expressions and functionality of the avatar 40, such as the emotes 45 and animations 47 of the avatar 40, for example.

The closet 35 may be provided as system software 37 associated with the multimedia console 100, as opposed to an avatar computing application. The closet 35 may be provided to the user 12 at any time over any computing application. For example, the closet 35 may be provided to the user 12 while an avatar computing application is being run. In this manner, the user 12 may modify the avatar 40 while playing a computer game or in another computing application or environment that renders or otherwise uses the avatar 40. The user interface of the closet 35 may not interfere with the underlying software (e.g., an avatar computing application) that is being run, apart from notifying the underlying software when the closet 35 is being provided to the user 40 or when it is being closed. The closet 35 may also provide notification to the software when the accessories or other expressions or functionality have been changed via the closet 35.

A profile of the user 12 may be stored in the storage device 72 and may record the set of currently applied accessories to an avatar, as well as the larger set of accessories that the user 12 currently owns. Once in the closet 35, the user 12 may remove accessories 43 applied to the avatar 40 and/or apply new accessories 43.

In an implementation, the closet 35 may allow the user 12 to apply accessories 43 they already own, as well as to try on accessories they do not own, as stored in the marketplace 70 for example, and to purchase the accessories before applying them. Thus, the user 12 may also browse the accessories available in the marketplace 70 for purchase, previewing items on the avatar 40 before deciding to purchase them. The closet 35 may notify an avatar computing application when an accessory is to be shown on the avatar 40 and when it is to be removed from the avatar 40 or otherwise not shown. The closet 35 may notify an avatar computing application if the set of applied accessories changes. The avatar computing application may accordingly change the appearance of the avatar 40 and retrieve accessories for rendering on the avatar 40.

The avatar system 30 may comprise a standard set of emotes 45 and animations 47 for the avatar that may be used by any avatar computing application without specific knowledge of how the emote or animation is rendered within the environment corresponding to the avatar computing application. This allows the user 12 to see a consistent avatar personality over multiple separate avatar computing applications. The emotes 45 and animations 47 may comprise standard movements that may be applied to the skeletal structure 41.

In an implementation, the emotes 45 and animations 47 may be generated by the user 12, may be obtained from the marketplace 70 or other online source, or may be obtained from fixed media such as optical media, memory cards, etc.

It is contemplated that the avatar system 30 may provide an avatar with accessories, emotes, and animations that are released after the avatar computing application itself has been released. The avatar computing application may use programming APIs to incorporate such an avatar.

One or more additional computing device 80a, 80b may be implemented in the computing environment 10. Similar to the multimedia console 100, each computing device may have an associated user and may run one or more avatar computing applications that may be a computer game or other application that renders or otherwise uses an avatar in an environment such as a chat, a forum, a community, or an instant messaging service. Each computing device may be a multimedia console, a PC, a gaming console, a handheld computing device, a PDA, a mobile phone, etc. Although only two computing devices 80a, 80b are illustrated in FIG. 1, it is contemplated than any number of computing devices may be implemented in the computing environment 10.

The multimedia console 100 and/or the computing devices 80a, 80b may be in communication with one another via a network 60, such as an intranet, the Internet, a local area network (LAN), a wide area network (WAN), a wireless fidelity (WiFi) network, a public switched telephone network (PSTN), a cellular network, a voice over Internet protocol (VoIP) network, and the like. Furthermore, the multimedia console 100 and/or the computing devices 80a, 80b may be in communication with the marketplace 70 and/or the storage device 72 via the network 60.

Each computing device 80a, 80b may have system software and a renderer, and may access the storage device 72 or other storage for data pertaining to a user and an avatar. In an implementation, the avatar 40 and its accessories 43, emotes 45, and animations 47 may be available and provided across multiple platforms such as the computing devices 80a, 80b. The data to render the avatar 40 may be exposed to the computing devices 80a, 80b via the network 60. For example, the computing device 80a may comprise a web-enabled handheld computing device, and the computing device 80b may comprise a mobile phone. The avatar 40, along with its accessories 43, emotes 45, and animations 47 may be rendered to the user 12 on any of the platforms, such as the web-enabled handheld computing device and the mobile phone. Thus, the same avatar functionality that may be available on the multimedia console 100 may also be available on other types of computing devices.

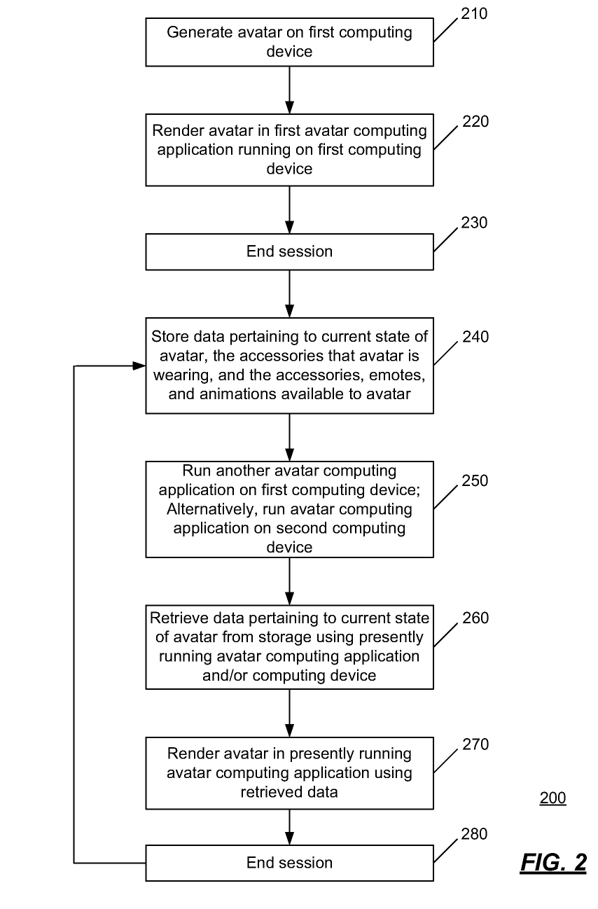

FIG. 2 is an operational flow of an implementation of a method 200 for providing an avatar across multiple computing environments. At 210, an avatar may be generated on a first computing device, such as the multimedia console 100. The avatar may be generated by a user and/or a computing application, such as an avatar computing application or other computing application associated with the computing device. The avatar and its accessories, emotes, and animations may be stored in storage associated with the first computing device. A profile of the user may also be stored.

At 220, the avatar may be rendered in a first avatar computing application running on the first computing device. For example, the user may be playing a computer game in a session on the first computing device that renders or otherwise displays the avatar. The session may end at 230. Data pertaining to the current state of the avatar, such as the accessories that the avatar is wearing, as well as the accessories, animations, and emotes that are available to the avatar, may be stored in storage at 240. In this manner, the avatar and the associated data may be used in other avatar computing applications running on the first computing device or on other computing devices.

At 250, another avatar computing application may be run on the first computing device. For example, the user may be playing another computer game that uses the avatar on the first computing device. Alternatively, an avatar computing application may be run on a second computing device that is maintained separately from the first computing device.

At 260, data pertaining to the current state of the avatar may be retrieved from storage by the presently running avatar computing application and/or the computing device that is presently running the avatar computing application. The avatar may be rendered or otherwise displayed in a session of the presently running avatar computing application at 270 using the retrieved data pertaining to the current state of the avatar. The session may end at 280, and processing may continue at 240 with data pertaining to the current state of the avatar being stored in storage.

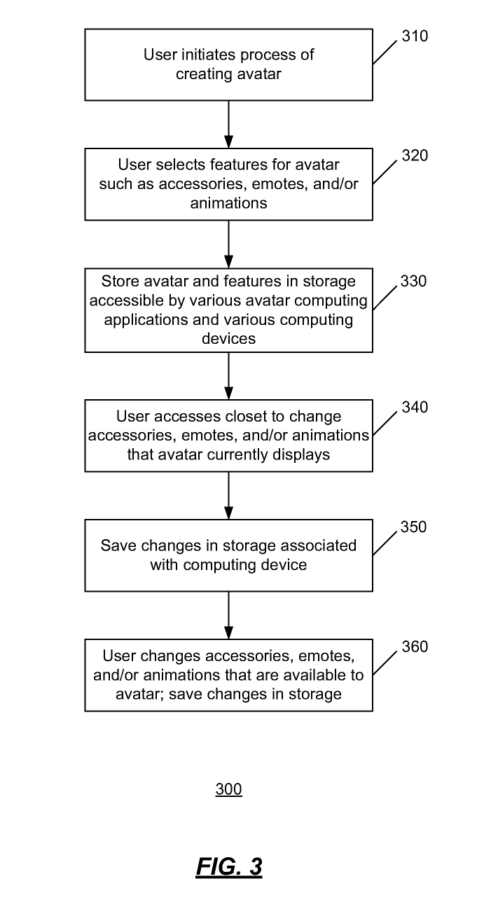

FIG. 3 is an operational flow of an implementation of a method 300 for providing features to an avatar. At 310, a user may initiate a process of creating an avatar for an avatar computing application or environment. The user may select or provide features such as accessories, emotes, and/or animations at 320, e.g. using an avatar system on a computing device. The avatar, along with its available accessories, emotes, and/or animations, may be stored in storage associated with the user at 330. As described further herein, the storage may be accessed by various avatar computing applications and various computing devices so that the avatar may be rendered or otherwise displayed throughout the avatar computing applications and environments.

At some point, at 340, the user may access the closet to change the accessories, emotes, and/or animations that are provided or displayed on the avatar in its current state. The closet may access storage and provide a listing of the available features to the user. Any changes may be saved in storage associated with the computing device at 350.

Additionally or alternatively, at 360, the user may change the accessories, emotes, and/or animations that are available to the avatar. The user may purchase accessories, emotes, and/or animations from a marketplace or other source or may otherwise obtain or provide such features. The accessories, emotes, and/or animations that are currently available for the avatar may be stored in storage.

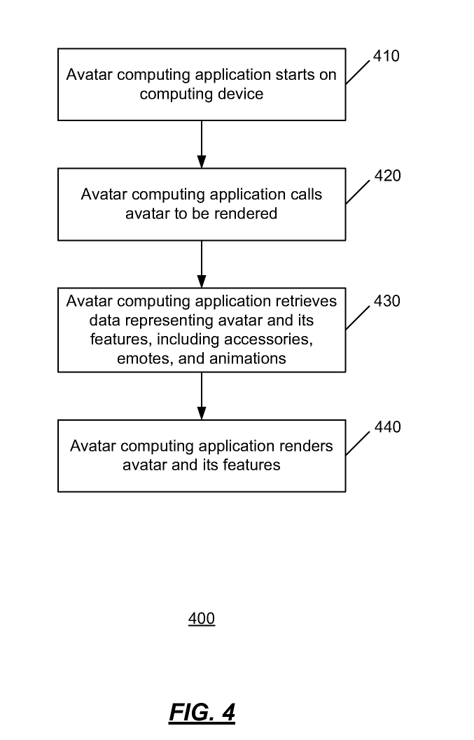

In an implementation, an avatar may be rendered by an avatar computing application. FIG. 4 is an operational flow of an implementation of a method 400 for rendering an avatar. At 410, an avatar computing application is started on a computing device. At 420, an avatar may be called by the avatar computing application to be rendered.

The avatar computing application may retrieve data representing the avatar from the computing device or storage associated with the computing device at 430. The data may comprise a skeletal structure of the avatar along with its features such as accessories, emotes, and animations. The game engine of the avatar computing application may use this data at 440 to render the avatar and its features. The avatar computing application may incorporate the data into its 3D character system so that it can render and animate the avatar in the computing application's own 3D environment.

In an implementation, the avatar computing application may use an API to retrieve the data, and then construct, render, and animate the avatar in the computing application's environment. The avatar computing application that renders the avatar may apply animation movements to a skeletal structure, but does not need to know any other specifics about the animation, such as what emotion or action the animation represents.

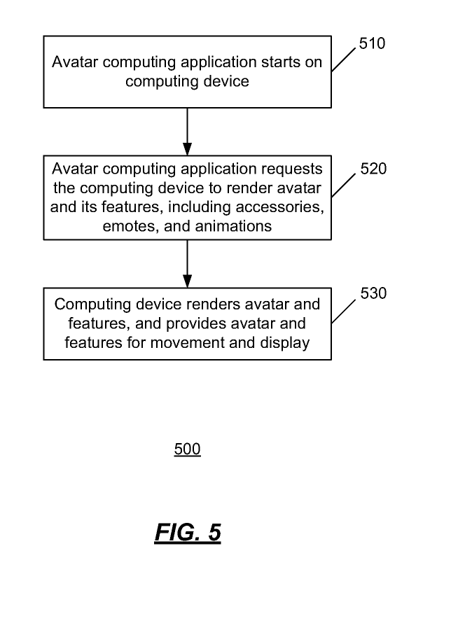

In an implementation, an avatar may be rendered by the computing device on which the avatar computing application is being run. FIG. 5 is an operational flow of another implementation of a method 500 for rendering an avatar. At 510, an avatar computing application is started on a computing device. At 520, the avatar computing application requests the computing device to render an avatar along with its features. In this manner, the avatar computing application does not have to understand how to apply movements or features to a skeletal structure. At 530, the computing device (e.g., the avatar system 30 on the computing device) may render the avatar and provide the avatar and its features and movements for display.

FIG. 6 illustrates functional components of an example multimedia console 100 computing environment. The multimedia console 100 has a central processing unit (CPU) 101 having a level 1 cache 102, a level 2 cache 104, and a flash ROM (read only memory) 106. The level 1 cache 102 and a level 2 cache 104 temporarily store data and hence reduce the number of memory access cycles, thereby improving processing speed and throughput. The CPU 101 may be provided having more than one core, and thus, additional level 1 and level 2 caches 102 and 104. The flash ROM 106 may store executable code that is loaded during an initial phase of a boot process when the multimedia console 100 is powered ON.

A graphics processing unit (GPU) 108 and a video encoder/video codec (coder/decoder) 114 form a video processing pipeline for high speed and high resolution graphics processing. Data is carried from the GPU 108 to the video encoder/video codec 114 via a bus. The video processing pipeline outputs data to an A/V (audio/video) port 140 for transmission to a television or other display. A memory controller 110 is connected to the GPU 108 to facilitate processor access to various types of memory 112, such as, but not limited to, a RAM (random access memory).

The multimedia console 100 includes an I/O controller 120, a system management controller 122, an audio processing unit 123, a network interface controller 124, a first USB host controller 126, a second USB controller 128, and a front panel I/O subassembly 130 that are preferably implemented on a module 118. The USB controllers 126 and 128 serve as hosts for peripheral controllers 142(1)-142(2), a wireless adapter 148, and an external memory device 146 (e.g., flash memory, external CD/DVD ROM drive, removable media, etc.). The network interface controller 124 and/or wireless adapter 148 provide access to a network (e.g., the Internet, home network, etc.) and may be any of a wide variety of various wired or wireless interface components including an Ethernet card, a modem, a Bluetooth module, a cable modem, and the like.

System memory 143 is provided to store application data that is loaded during the boot process. A media drive 144 is provided and may comprise a DVD/CD drive, hard drive, or other removable media drive, etc. The media drive 144 may be internal or external to the multimedia console 100. Application data may be accessed via the media drive 144 for execution, playback, etc. by the multimedia console 100. The media drive 144 is connected to the I/O controller 120 via a bus, such as a serial ATA bus or other high speed connection (e.g., IEEE 1394).

The system management controller 122 provides a variety of service functions related to assuring availability of the multimedia console 100. The audio processing unit 123 and an audio codec 132 form a corresponding audio processing pipeline with high fidelity and stereo processing. Audio data is carried between the audio processing unit 123 and the audio codec 132 via a communication link. The audio processing pipeline outputs data to the A/V port 140 for reproduction by an external audio player or device having audio capabilities.

The front panel I/O subassembly 130 supports the functionality of the power button 150 and the eject button 152, as well as any LEDs (light emitting diodes) or other indicators exposed on the outer surface of the multimedia console 100. A system power supply module 136 provides power to the components of the multimedia console 100. A fan 138 cools the circuitry within the multimedia console 100.

The CPU 101, GPU 108, memory controller 110, and various other components within the multimedia console 100 are interconnected via one or more buses, including serial and parallel buses, a memory bus, a peripheral bus, and a processor or local bus using any of a variety of bus architectures.

When the multimedia console 100 is powered ON, application data may be loaded from the system memory 143 into memory 112 and/or caches 102, 104 and executed on the CPU 101. The application may present a graphical user interface that provides a consistent user experience when navigating to different media types available on the multimedia console 100. In operation, applications and/or other media contained within the media drive 144 may be launched or played from the media drive 144 to provide additional functionalities to the multimedia console 100.

The multimedia console 100 may be operated as a standalone system by simply connecting the system to a television or other display. In this standalone mode, the multimedia console 100 allows one or more users to interact with the system, watch movies, or listen to music. However, with the integration of broadband connectivity made available through the network interface controller 124 or the wireless adapter 148, the multimedia console 100 may further be operated as a participant in a larger network community.

When the multimedia console 100 is powered ON, a set amount of hardware resources are reserved for system use by the multimedia console operating system. These resources may include a reservation of memory (e.g., 16 MB), CPU and GPU cycles (e.g., 5%), networking bandwidth (e.g., 8 kbs), etc. Because these resources are reserved at system boot time, the reserved resources do not exist from the application's view.

In particular, the memory reservation preferably is large enough to contain the launch kernel, concurrent system applications, and drivers. The CPU reservation is preferably maintained at a constant level.

With regard to the GPU reservation, lightweight messages generated by the system applications (e.g., popups) are displayed by using a GPU interrupt to schedule code to render popups into an overlay. The amount of memory used for an overlay depends on the overlay area size and the overlay preferably scales with screen resolution. Where a full user interface is used by the concurrent system application, it is preferable to use a resolution independent of game resolution. A scaler may be used to set this resolution such that the need to change frequency and cause a TV resynch is eliminated.

After the multimedia console 100 boots and system resources are reserved, concurrent system applications execute to provide system functionalities. The system functionalities are encapsulated in a set of system applications that execute within the reserved system resources described above. The operating system kernel identifies threads that are system application threads versus multimedia application threads. The system applications are preferably scheduled to run on the CPU 101 at predetermined times and intervals in order to provide a consistent system resource view to the application. The scheduling is to minimize cache disruption for the multimedia application running on the console.

When a concurrent system application requires audio, audio processing is scheduled asynchronously to the multimedia application due to time sensitivity. A multimedia console application manager controls the multimedia application audio level (e.g., mute, attenuate) when system applications are active.

Input devices (e.g., controllers 142(1) and 142(2)) are shared by multimedia applications and system applications. The input devices are not reserved resources, but are to be switched between system applications and the multimedia application such that each will have a focus of the device. The application manager preferably controls the switching of input stream, without knowledge the multimedia application's knowledge and a driver maintains state information regarding focus switches.

It should be understood that the various techniques described herein may be implemented in connection with hardware or software or, where appropriate, with a combination of both. Thus, the processes and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might include PCs, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method of providing an avatar across a plurality of computing environments, comprising:
rendering an avatar and a plurality of features in a first computing application;
storing data pertaining to the avatar and the features rendered in the first computing application;
rendering the avatar and the features in a second computing application based on the stored data.

2. The method of claim 1, wherein the features comprise at least one of a plurality of accessories, emotes, or animations.

3. The method of claim 1, wherein the first computing application comprises a first computer game, and the second computing application comprises one of a second computer game, a chat, a forum, a community, or an instant messaging service.

4. The method of claim 1, wherein the first computing application and the second computing application run on a computing device.

5. The method of claim 4, wherein the computing device comprises a multimedia console.

6. The method of claim 1, wherein the first computing application runs on a first computing device and the second computing application runs on a second computing device separate from the first computing device.

7. The method of claim 6, wherein the first computing device comprises a different platform than the second computing device.

8. The method of claim 1, wherein storing data pertaining to the avatar and the features comprises storing data pertaining to a current state of the avatar and data pertaining to a plurality of accessories available to the avatar.

9. The method of claim 1, wherein storing data comprises storing the data in storage that is accessible to a plurality of computing devices, each computing device maintaining an environment for the avatar.

10. A method of providing a feature to an avatar, comprising:
receiving a selection of a feature for an avatar; and
storing data pertaining to the avatar and the feature in a storage accessible to a plurality of avatar computing applications.

11. The method of claim 10, wherein the feature comprises an accessory, an emote, or an animation.

12. The method of claim 10, wherein the storage is accessible to a plurality of computing devices, each computing device providing a different platform for the avatar.

13. The method of claim 10, further comprising providing a closet to a user, the closet comprising a plurality of accessories for the avatar, the accessories being selectable by the user.

14. The method of claim 13, further comprising receiving a selection of one of the accessories from the user via the closet, providing the accessory to the avatar, and storing data pertaining to the accessory in the storage.

15. The method of claim 13, further comprising storing data pertaining to the feature in the closet.

16. An avatar system, comprising:
an avatar that is available across a plurality of environments associated with a plurality of avatar computing applications; and
a storage device comprising data pertaining to the avatar and is accessible by the avatar computing applications.

17. The system of claim 16, further comprising at least one of a plurality of accessories, emotes, or animations that are available across the environments associated with the avatar computing applications, the storage device further comprising data pertaining to the accessories, emotes, or animations.

18. The system of claim 17, wherein each of the avatar computing applications is associated with a different one of a plurality of computing devices.

19. The system of claim 18, wherein the plurality of computing devices comprises at least one multimedia console and at least one web-enabled computing device.

20. The system of claim 16, further comprising a skeletal structure for the avatar, the skeletal structure for animation of the avatar by each of the avatar computing applications.
